(19) United States
(12) Patent Application Publication
(10) Pub. No.: US 2026/0231130 A1
(43) Pub. Date: Aug. 6, 2026

(54) METHOD FOR ANNOUNCING PUNCTURING PATTERN TO ACCESS POINT AND ASSOCIATED WIRELESS COMMUNICATION DEVICE

(71) Applicant: MEDIATEK INC., Hsin-Chu (TW)

(72) Inventors: Hung-Tao Hsieh, Hsinchu City (TW); Chien-Fang Hsu, Hsinchu City (TW)

(21) Appl. No.: 19/152,925

(22) PCT Filed: Feb. 2, 2024
(86) PCT No.: PCT/CN2024/075457

§ 371 Date: Jul. 31, 2025

Related U.S. Application Data
(60) Provisional application No. 63/482,815, filed on Feb. 2, 2023.
(60) Provisional application No. 63/491,781, filed on Mar. 23, 2023.
(60) Provisional application No. 63/587,756, filed on Oct. 4, 2023.

(51) Int. Cl. H04W 72/0453; H04L 1/00

(52) U.S. Cl. CPC H04W 72/0453; H04L 1/0069

(57) ABSTRACT

A wireless communication method includes: generating first information indicative of a first puncturing pattern of a bandwidth claimed by an access point (AP), wherein the first puncturing pattern indicates at least one subchannel to be punctured in the bandwidth; and sending the first information to the AP. For example, the first information includes a subchannel bitmap and a subchannel bandwidth.

### BACKGROUND OF THE INVENTION

### 1. Field of the Invention

The present invention relates to wireless communications, and more particularly, to a method for announcing a puncturing pattern to an access point and an associated wireless communication device.

### 2. Description of the Prior Art

An access point (AP) usually has a larger bandwidth (BW) support than the non-AP stations (STAs), and the gap between two supported BWs of the AP is getting larger while the 320 MHz BW is introduced in the 6GHz band. For example, in 802.11be, one supported BW may be 320 MHz, and another supported BW may be 160 MHz. This gap can be even larger while people are attempting to use the 640 MHz BW in the 6GHz band. However, a non-AP STA may be capable of supporting a BW between two BWs claimed by the AP, e.g., 240 MHz between 160 MHz and 320 MHz, to control the cost required to support the large bandwidth and to enjoy the benefits by adding extra bandwidth (e.g., 160 MHz to 240MHz). Thus, there is a need for an innovative design that allows downlink (DL) and uplink (UL) traffic between AP and non-AP STA to benefit from extra bandwidth without adding more BWs and corresponding supported modulation and coding scheme (MCS) sets.

### SUMMARY OF THE INVENTION

One of the objectives of the claimed invention is to provide a method for announcing a puncturing pattern to an access point and an associated wireless communication device.

According to a first aspect of the present invention, an exemplary wireless communication method is disclosed. The exemplary wireless communication method includes: generating first information indicative of a first puncturing pattern of a bandwidth claimed by an access point (AP), wherein the first puncturing pattern indicates at least one subchannel to be punctured in the bandwidth; and sending the first information to the AP.

According to a second aspect of the present invention, an exemplary wireless communication device is disclosed. The exemplary wireless communication device includes a network interface circuit and a control circuit. The control circuit is arranged to generate first information indicative of a first puncturing pattern of a bandwidth claimed by an access point (AP), and instruct the network interface circuit to send the first information to the AP, wherein the first puncturing pattern indicates at least one subchannel to be punctured in the bandwidth.

According to a third aspect of the present invention, an exemplary wireless communication method is disclosed. The exemplary wireless communication method includes: generating information indicative of a maximum modulation and coding scheme (MCS) index for a first bandwidth and a maximum MCS index for a second bandwidth, wherein the second bandwidth is larger than the first bandwidth, and the maximum MCS index for the second bandwidth is not larger than the maximum MCS index for the first bandwidth; and sending the information to a wireless communication device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless communication system that supports the proposed bandwidth puncturing scheme according to an embodiment of the present invention.

FIG. 2 is a diagram illustrating a bandwidth with contiguous puncturing and a bandwidth with split puncturing according to an embodiment of the present invention.

FIG. 3 is a diagram illustrating maximum MCS indexes claimed for different bandwidths to achieve similar PHY rates according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

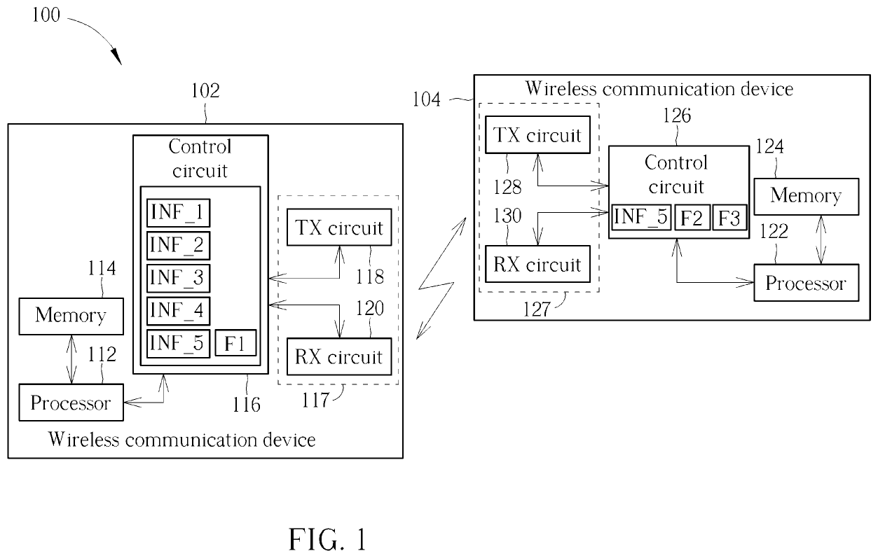

FIG. 1 is a diagram illustrating a wireless communication system that supports the proposed bandwidth puncturing scheme according to an embodiment of the present invention. The wireless communication system 100 includes a plurality of wireless communication devices 102 and 104. For example, the wireless communication system 100 is a Wi-Fi system, including an AP and a non-AP STA. In one embodiment of the present invention, the wireless communication device 102 may be a non-AP STA, and the wireless communication device 104 may be an AP. That is, the wireless communication device 102 may be a client STA that is associated to the AP. For brevity and simplicity, only two wireless communication devices 102 and 104 are shown in FIG. 1. In practice, the wireless communication system 100 is allowed to have more than two wireless communication devices, including an AP and more than one non-AP STA in the same basic service set (BSS).

The wireless communication devices 102 and 104 may have the same or similar circuit structure. As shown in FIG. 1, the wireless communication device 102 includes a processor 112, a memory 114, a control circuit 116, and a network interface circuit 117, where the network interface circuit 117 includes a transmitter (TX) circuit 118 and a receiver (RX) circuit 120. The memory 114 is arranged to store a program code. The processor 112 is arranged to load and execute the program code to manage the wireless communication device 102. The control circuit 116 is arranged to control wireless communications with the wireless communication device 104. In a case where the wireless communication device 102 is a non-AP STA and the wireless communication device 104 is an AP, the control circuit 116 controls the TX circuit 118 of the network interface circuit 117 to deal with UL traffic between AP and non-AP STA, and controls the RX circuit 120 of the network interface circuit 117 to deal with DL traffic between AP and non-AP STA.

The wireless communication device 104 includes a processor 122, a memory 124, a control circuit 126, and a network interface circuit 127, where the network interface circuit 127 includes a TX circuit 128 and an RX circuit 130. The memory 124 is arranged to store a program code. The processor 122 is arranged to load and execute the program code to manage the wireless communication device 104. The control circuit 126 is arranged to control wireless communications with the wireless communication device 102. In a case where the wireless communication device 102 is a non-AP STA and the wireless communication device 104 is an AP, the control circuit 126 controls the TX circuit 128 of the network interface circuit 127 to deal with DL traffic between AP and non-AP STA, and controls the RX circuit 130 of the network interface circuit 127 to deal with UL traffic between AP and non-AP STA.

It should be noted that only the components pertinent to the present invention are illustrated in FIG. 1. In practice, the wireless communication device 102 may include additional components to achieve designated functions, and/or the wireless communication device 104 may include additional components to achieve designated functions.

The wireless communication devices 102 acts as a client STA that is associated to the wireless communication device 104 that acts as an AP, and supports a puncturing pattern announcement function. Hence, the control circuit 116 of the wireless communication device (e.g., non-AP STA) 102 generates information INF_1 indicative of a puncturing pattern of a bandwidth claimed by the wireless communication device (e.g., AP) 104, and instructs the network interface circuit 117 (particularly, TX circuit 118 of network interface circuit 117) to send the information INF_1 to the wireless communication device (e.g., AP) 104. For example, the bandwidth to be punctured may be the largest claimed bandwidth (e.g., 320 MHz) of the wireless communication device (e.g., AP) 104, and the information INF_1 may be generated and sent during an association process between the wireless communication device (e.g., non-AP STA) 102 and the wireless communication device (e.g., AP) 104. The puncturing pattern announced by the wireless communication device (e.g., non-AP STA) 102 indicates one or more subchannels (also called subbands) to be punctured in the bandwidth (e.g., largest bandwidth) claimed by the wireless communication device (e.g., AP) 104.

In some embodiments of the present invention, the information INF_1 may include a subchannel bitmap used to indicate which subchannel(s) are punctured. For example, the lowest numbered bit of the subchannel bitmap may correspond to a subchannel (e.g., 20 MHz subchannel) that lies within the bandwidth (e.g., 320 MHz) to be punctured and has the lowest frequency, and each successive bit in the subchannel bitmap may correspond to the next higher frequency subchannel. A bit in the subchannel bitmap is set to 1 to indicate that a corresponding subchannel (e.g., 20 MHz subchannel) is punctured, and is set to 0 to indicate that the corresponding subchannel (e.g., 20 MHz subchannel) is not punctured. It should be noted that the primary subchannel (BW20) is not punctured.

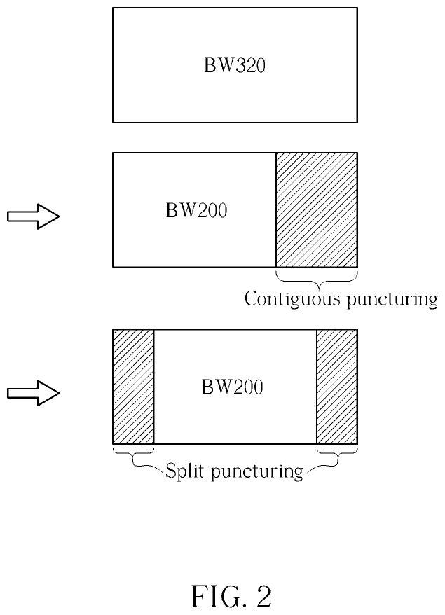

As mentioned above, the subchannel bitmap is used to indicate which subchannel(s) are punctured. Hence, with a proper setting of the subchannel bitmap, the puncturing pattern announced by the wireless communication device (e.g., non-AP STA) 102 may apply contiguous puncturing or split puncturing to the bandwidth, as illustrated in FIG. 2.

In some embodiments of the present invention, the information INF_1 may further include a subchannel bandwidth that may be defined as 20 MHz, 40 MHz, or a larger value. The bandwidth (e.g., 320 MHz) to be punctured may include a plurality of subchannels, each having the same subchannel bandwidth indicated by the information INF_1. The subchannel bandwidth is set according to actual design considerations. For example, using a larger subchannel bandwidth can bring less complexity of subchannel filtering and/or subchannel indication.

The bandwidth with puncturing as defined by the subchannel bitmap and the subchannel bandwidth indicated by the information INF_1 may be used for DL physical layer protocol data units (PPDUs) and UL PPDUs. The PPDU can be a trigger-based (TB) PPDU, a multi-user (MU) PPDU, or a single-user (SU) PPDU. Specifically, a DL PPDU received from the wireless communication device (e.g., AP) 104 is within the bandwidth with puncturing defined by the puncturing pattern indicated by the information INF_1, and a UL PPDU sent to the wireless communication device (e.g., AP) 104 is within the bandwidth with puncturing defined by the same puncturing pattern indicated by the information INF_1.

In an alternative design, the control circuit 116 of the wireless communication device (e.g., non-AP STA) 102 further generates information INF_2 indicative of another puncturing pattern of the same bandwidth claimed by the wireless communication device (e.g., AP) 104, and instructs the network interface circuit 117 (particularly, TX circuit 118 of network interface circuit 117) to send the information INF_2 to the wireless communication device (e.g., AP) 104. Similarly, the information INF_2 may include a subchannel bitmap and a subchannel bandwidth that define another puncturing pattern announced by the wireless communication device 102. For example, the bandwidth with puncturing as defined by the subchannel bitmap and the subchannel bandwidth indicated by the information INF_1 may be used for DL PPDUs, and the bandwidth with puncturing as defined by the subchannel bitmap and the subchannel bandwidth indicated by the information INF_2 (INF_2 #INF_1) may be used for UL PPDUs. The PPDU can be a TB PPDU, an MU PPDU, or an SU PPDU. Specifically, a DL PPDU received from the wireless communication device (e.g., AP) 104 is within the bandwidth with puncturing defined by the puncturing pattern indicated by the information INF_1, and a UL PPDU sent to the wireless communication device (e.g., AP) 104 is within the bandwidth with puncturing defined by a different puncturing pattern indicated by the information INF_2.

With the use of puncturing pattern indication announced by the client STA, certain benefits can be obtained. For example, extra BW support between two claimed BWs of AP, such as 320 MHz and 160 MHz, is enabled, thereby allowing the client STA to choose to support the 240 MHz bandwidth. Since the supported BW is chosen by the client STA, extra design flexibility for the client STA is added, and there is no extra BW support complexity on the AP side. For another example, regarding power saving, the client STA may want to keep lower BW support while claiming support of a larger BW.

In addition to the puncturing pattern, an MCS set supported by the bandwidth with puncturing may also be announced by the wireless communication device (e.g., non-AP STA) 102. Specifically, the control circuit 116 generates information INF_3 indicative of an MCS set supported by the bandwidth with puncturing defined by a puncturing pattern (which is indicated by the information INF_1/INF_2), and instructs the network interface circuit 117 (particularly, TX circuit 118 of network interface circuit 117) to send the information INF_3 to the wireless communication device (e.g., AP) 104. The MCS set may include MCS and spatial stream (SS). The MCS set indicated by the information INF_3 may be within the claimed MCS sets, or may be a new MCS set different from any other BWs' MCS sets. In some embodiments of the present invention, the MCS sets for DL and UL PPDUs with bandwidth puncturing may be different, or may be the same to reduce complexity.

The information INF_1/INF_2 indicative of the puncturing pattern may be generated and sent during an association process between the wireless communication device (e.g., non-AP STA) 102 and the wireless communication device (e.g., AP) 104. After the association process (i.e., after the client STA is associated to the AP), the wireless communication device (e.g., non-AP STA) 102 may need to update the puncturing pattern and/or MCS set for different usage scenarios. Specifically, the control circuit 116 generates information INF_4 indicative of updated parameter(s) of the puncturing pattern (which is indicated by information INF_1/INF_2 during association) and/or the MCS set (which is indicated by information INF_3 during association), and instructs the network interface circuit 117 (particularly, TX circuit 118 of network interface circuit 117) to send the information INF_4 to the wireless communication device (e.g., AP) 104 for updating the puncturing pattern and/or the MCS set.

In a first exemplary design, a negotiation-based update mechanism may be employed. Hence, the control circuit 116 generates a frame F1 (which is a request frame) that contains the information INF_4, and instructs the network interface circuit 117 (particularly, TX circuit 118 of network interface circuit 117) to send the frame F1 (which is a request frame) to the wireless communication device (e.g., AP) 104. After the control circuit 126 receives the frame F1 (which is a request frame) via the network interface circuit 127 (particularly, RX circuit 130 of network interface circuit 127), the control circuit 126 generates a frame F2 (which is a response frame), and instructs the network interface circuit 127 (particularly, TX circuit 128 of network interface circuit 127) to send the frame F2 (which is a response frame) to the wireless communication device (e.g., non-AP STA) 102. If the wireless communication device (e.g., AP) 104 accepts the update request, the frame F2 with a confirmation message is sent to the wireless communication device (e.g., non-AP STA) 102. After the update is confirmed and complete, the updated puncturing pattern and/or updated MCS set can be applied while the wireless communication device (e.g., AP) 104 sends a DL PPDU to the wireless communication device (e.g., non-AP STA) 102. If the wireless communication device (e.g., AP) 104 rejects the update request, the frame F2 with a rejection message is sent to the wireless communication device (e.g., non-AP STA) 102.

The timing (waiting period) to transmit the response frame can be further defined so that the AP needs to respond in time after receiving the request from the client STA. For example, the timing (waiting period) can be defined by Target Beacon Transmission Time (TBTT). That is, after receiving the request frame, the AP needs to respond within N TBTTs. For another example, the timing (waiting period) can be announced by the client STA or by the AP during the association.

In a second exemplary design, a notification-based update mechanism may be employed. Hence, the control circuit 116 generates a frame F1 (which is a notification frame) that contains the information INF 4, and instructs the network interface circuit 117 (particularly, TX circuit 118 of network interface circuit 117) to send the frame F1 (which is a notification frame) to the wireless communication device (e.g., AP) 104. After the control circuit 126 receives the frame F1 (which is a notification frame) via the network interface circuit 127 (particularly, RX circuit 130 of network interface circuit 127), the control circuit 126 generates a frame F2 (which is an acknowledgment (ACK) frame), and instructs the network interface circuit 127 (particularly, TX circuit 128 of network interface circuit 127) to send the frame F2 (which is an ACK frame) to the wireless communication device (e.g., non-AP STA) 102. For example, the ACK frame is usually carried on a PPDU that is a Short Interframe Space (SIFS) after a PPDU carrying the request frame. Once the wireless communication device (e.g., AP) 104 sends the ACK frame in response to the request frame, the update is confirmed and complete. After the update is confirmed and complete, the updated puncturing pattern and/or updated MCS set can be applied while the wireless communication device (e.g., AP) 104 sends a DL PPDU to the wireless communication device (e.g., non-AP STA) 102. It should be noted that the wireless communication device (e.g., AP) 104 may not send the ACK frame in response to the request frame because of interference or other reasons.

In some embodiments of the present invention, the wireless communication device (e.g., non-AP STA) 102 may also announce the capability of puncturing pattern update with corresponding MCS during the association process. Hence, the wireless communication device (e.g., AP) 104 is allowed to request the wireless communication device (e.g., non-AP STA) 102 to update the puncturing pattern and/or MCS set for different usage scenarios. Specifically, the control circuit 126 generates a frame F3 (which is a request frame), and instructs the network interface circuit 127 (particularly, TX circuit 128 of network interface circuit 127) to send the frame F3 (which is a request frame) to the wireless communication device (e.g., non-AP STA) 102. The control circuit 116 receives the frame F3 (which is a request frame) via the network interface circuit 117 (particularly, RX circuit 120 of network interface circuit 117). If the wireless communication device (e.g., non-AP STA) 102 accepts the update request, the control circuit 116 generates the information INF_4 indicative of updated parameter(s) of the puncturing pattern (which is indicated by information INF_1/INF_2 during association) and/or the MCS set (which is indicated by information INF_3 during association), and instructs the network interface circuit 117 (particularly, TX circuit 118 of network interface circuit 117) to send the information INF 4 to the wireless communication device (e.g., AP) 104 for updating the puncturing pattern (which is indicated by information INF_1/INF_2 during association) and/or the MCS set (which is indicated by information INF_3 during association). One of the negotiation-based update mechanism and the notification-based mechanism mentioned above may be employed to confirm and complete the update.

In some embodiments, the wireless communication device (e.g., non-AP STA) 102 may also announce the capability of updating UL MCS support of corresponding bandwidth during the association process. The wireless communication device (e.g., AP) 104 may send a request frame to request the wireless communication device (e.g., non-AP STA) 102 to have a different UL MCS support of the corresponding bandwidth. The wireless communication device (e.g., non-AP STA) 102 may accept or reject the update request by sending a response frame. In a case where the wireless communication device (e.g., non-AP STA) 102 rejects the update request, the wireless communication device (e.g., non-AP STA) 102 may provide a counter MCS support suggestion to the wireless communication device (e.g., AP) 104 through the response frame.

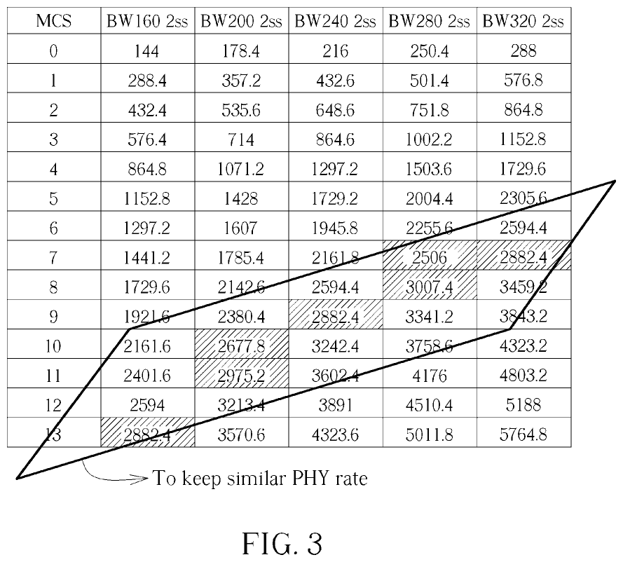

In general, the physical layer (PHY) rate is proportional to the bandwidth under the same MCS, as illustrated in FIG. 3. Considering some factors, including intra-chip throughput, medium access control (MAC) cost, processor loading, etc., it is preferable to limit an upper bound for the PHY rate. To keep similar DL/UL PHY rate, a client STA or AP can claim the maximum MCS indexes for different bandwidths via negotiation.

Regarding the wireless communication device (e.g., non-AP STA) 102, the control circuit 116 generates information INF_5 indicative of maximum MCS indexes for different bandwidths (e.g., a maximum MCS index for a first bandwidth and a maximum MCS index for a second bandwidth, where the second bandwidth is larger than the first bandwidth, and the maximum MCS index for the second bandwidth is not larger than the maximum MCS index for the first bandwidth), and instructs the network interface circuit 117 (particularly, TX circuit 118 of network interface circuit 117) to send the information INF_5 to the wireless communication device (e.g., AP) 104.

Regarding the wireless communication device (e.g., AP) 104, the control circuit 126 generates information INF_5 indicative of maximum MCS indexes for different bandwidths (e.g., a maximum MCS for a first bandwidth and a maximum MCS index for a second bandwidth, where the second bandwidth is larger than the first bandwidth, and the maximum MCS index for the second bandwidth is not larger than the maximum MCS index for the first bandwidth), and instructs the network interface circuit 127 (particularly, TX circuit 128 of network interface circuit 127) to send the information INF_5 to the wireless communication device (e.g., non-AP STA) 102.

Similar PHY rates are marked by slashed areas in the table shown in FIG. 3. In accordance with the similar PHY rates shown in FIG. 3, the information INF_5 may be set to indicate that the maximum MCS index for 160 MHz BW and 2 spatial streams (labeled by “BW160 2ss”) is MCS=13, the maximum MCS index for 200 MHz BW and 2 spatial streams (labeled by “BW200 2ss”) is MCS=10 or 11, the maximum MCS index for 240 MHz BW and 2 spatial streams (labeled by “BW240 2ss”) is MCS=9, the maximum MCS index for 280 MHz BW and 2 spatial streams (labeled by “BW280 2 ss”) is MCS=7 or 8, and the maximum MCS index for 320 MHZ BW and 2 spatial streams (labeled by “BW320 2ss”) is MCS=7. However, this is for illustrative purposes only, and is not meant to be a limitation of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communication method comprising:
generating first information indicative of a first puncturing pattern of a bandwidth claimed by an access point (AP), wherein the first puncturing pattern indicates at least one subchannel to be punctured in the bandwidth; and
sending the first information to the AP.

2. The wireless communication method of claim 1, wherein the first information comprises a subchannel bitmap that indicates the at least one subchannel to be punctured.

3. The wireless communication method of claim 1, wherein the first information comprises a subchannel bandwidth.

4. The wireless communication method of claim 1, wherein a downlink (DL) physical layer protocol data unit (PPDU) received from the AP is within the bandwidth with puncturing defined by the first puncturing pattern, and an uplink (UL) PPDU sent to the AP is within the bandwidth with puncturing defined by the first puncturing pattern.

5. The wireless communication method of claim 1, further comprising:
generating second information indicative of a second puncturing pattern of the bandwidth claimed by the AP; and
sending the second information to the AP.

6. The wireless communication method of claim 5, wherein a downlink (DL) physical layer protocol data unit (PPDU) received from the AP is within the bandwidth with puncturing defined by the first puncturing pattern, and an uplink (UL) PPDU sent to the AP is within the bandwidth with puncturing defined by the second puncturing pattern.

7. The wireless communication method of claim 1, further comprising:
generating second information indicative of a modulation and coding scheme (MCS) set supported by the bandwidth with puncturing defined by the first puncturing pattern, wherein the MCS set comprises MCS and spatial stream (SS); and
sending the second information to the AP.

8. The wireless communication method of claim 7, further comprising:
generating third information indicative of at least one updated parameter of at least one of the first puncturing pattern and the MCS set; and
sending the third information to the AP for updating the at least one of the first puncturing pattern and the MCS set.

9. The wireless communication method of claim 8, wherein generating the third information indicative of the at least one updated parameter of the at least one of the first puncturing pattern and the MCS set comprises:
receiving a request frame from the AP; and
in response to the request frame, generating the third information.

10. A wireless communication device comprising:
a network interface circuit; and
a control circuit, arranged to generate first information indicative of a first puncturing pattern of a bandwidth claimed by an access point (AP), and instruct the network interface circuit to send the first information to the AP, wherein the first puncturing pattern indicates at least one subchannel to be punctured in the bandwidth.

11. The wireless communication device of claim 10, wherein the first information comprises a subchannel bitmap that indicates the at least one subchannel to be punctured.

12. The wireless communication device of claim 10, wherein the first information comprises a subchannel bandwidth.

13. The wireless communication device of claim 10, wherein a downlink (DL) physical layer protocol data unit (PPDU) received from the AP via the network interface circuit is within the bandwidth with puncturing defined by the first puncturing pattern, and an uplink (UL) PPDU sent to the AP via the network interface circuit is within the bandwidth with puncturing defined by the first puncturing pattern.

14. The wireless communication device of claim 10, wherein the control circuit is further arranged to generate second information indicative of a second puncturing pattern of the bandwidth claimed by the AP, and instruct the network interface circuit to send the second information to the AP.

15. The wireless communication device of claim 14, wherein a downlink (DL) physical layer protocol data unit (PPDU) received from the AP via the network interface circuit is within the bandwidth with puncturing defined by the first puncturing pattern, and an uplink (UL) PPDU sent to the AP via the network interface circuit is within the bandwidth with puncturing defined by the second puncturing pattern.

16. The wireless communication device of claim 10, wherein the control circuit is further arranged to generate second information indicative of a modulation and coding scheme (MCS) set supported by the bandwidth with puncturing defined by the first puncturing pattern, and instruct the network interface circuit to send the second information to the AP, wherein the MCS set comprises MCS and spatial stream (SS).

17. The wireless communication device of claim 16, wherein the control circuit is further arranged to generate third information indicative of at least one updated parameter of at least one of the first puncturing pattern and the MCS set, and instruct the network interface to send the third information to the AP for updating the at least one of the first puncturing pattern and the MCS set.

18. The wireless communication device of claim 17, wherein the control circuit is further arranged to receive a request frame from the AP via the network interface circuit; and the third information is generated by the control circuit in response to the request frame.

19. A wireless communication method comprising:
generating information indicative of a maximum modulation and coding scheme (MCS) index for a first bandwidth and a maximum MCS index for a second bandwidth, wherein the second bandwidth is larger than the first bandwidth, and the maximum MCS index for the second bandwidth is not larger than the maximum MCS index for the first bandwidth; and
sending the information to a wireless communication device.

20. The wireless communication method of claim 19, wherein the wireless communication method is employed by an access point (AP), and the wireless communication device is a non-AP station (STA); or the wireless communication method is employed by the non-AP STA, and the wireless communication device is the AP.
